(19) United States
(12) Patent Application Publication
(10) Pub. No.: US 2007/0026738 A1
(43) Pub. Date: Feb. 1, 2007

(54) Accessory fuse harness

(76) Inventor: Roger Eichman, Nordland, WA (US)

Correspondence Address: Roger Eichman D.D.S., 223 Griffith Road, Nordland, WA, 98338, US

(21) Appl. No.: 11/190,273

(22) Filed: Jul. 26, 2005

(51) Int. Cl. H01R 13/68

(52) U.S. Cl. 439/620.29

(57) ABSTRACT

An improved accessory fuse harness is an inexpensive and easy means to power accessories such as entertainment, auxiliary, or communication equipment in vehicles such as passenger cars or boats from a standard fuse box and uses a connective plug that resembles the fuse utilized in the fuse box in appearance wired an accessory that is to be added to the vehicle.

### FIELD OF INVENTION

The present invention relates generally to an improved accessory fuse harness that allows easy connection of devices requiring power to existing systems to an existing fuse box, or with the addition of an addition fuse box.

### BACKGROUND OF THE INVENTION

Commonly used electrical devices such as computer accessories, cell phones, stereos, televisions, and music players such as MP3, CD etc., are now being used in automobiles and a wide variety of vehicles. The devices need electrical power to operate. Most vehicles have predetermined wiring systems that come from the factory, or have either none, or has limited outlets for the use with additional accessories that an end user would want to install. For example, automobiles have one power outlet, or use the cigarette lighter to power portable electronic equipment. Each of the factory installed accessories are wired to a power source via a fuse box that comes with the vehicle.

Fuse boxes come with nearly all vehicles. Some fuse boxes have unused fuse locations that can be used to power other applications. However, this requires running wires the fuse box or to the main wiring system. A fuse box will typically have one lead from the fuse box to the power source and the other lead will go to the accessory that will typically have to be grounded.

Rarely, some blank fuse locations will be already wired to the electrical system on one prong only leaving one prong to be wired to an accessory. This still requires wiring to be ran in the vehicle. Adding wiring to any existing vehicle is typically very expensive. As a general rule newer vehicles are more costly to repair than older vehicles and are of more complexity. If the vehicle has a computer system that controls the wiring, the level of difficulty in adding wiring systems tends to increase.

The need therefore exists for an easy means to power accessories without expensive wiring installation.

### SUMMARY OF THE INVENTION

The instant invention is an improved accessory fuse harness that allows the user to provide a inexpensive and easy to use means to power accessories such as entertainment, auxiliary, or communication equipment in vehicles such as passenger cars or boats from a standard fuse box. This is done by means of a harness that has a connective plug that resembles the fuse utilized in the fuse box in appearance, but is pre-wired to provide connection points to an accessory that is to be added.

The subject matter of the present invention is particularly pointed out and distinctly claimed in the concluding portion of the specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1a is a top view of a vehicle that utilize a first embodiment of the instant invention to power an accessory under the hood.

FIG. 1b is a schematic diagram illustrating how the instant invention is used to connect an accessory to the existing fuse box that utilizes a fuse holder to protect the accessory from electrical surges.

FIG. 1c is a schematic diagram illustrating how the instant invention is used to connect an accessory to the existing fuse box.

FIG. 1d is an isometric view of a first embodiment of the instant invention illustrating the placement of the fuse holder.

FIG. 2 is an isometric view of a prior art electric harness.

FIG. 3 is an isometric view of a prior art in-line fuse holder.

FIG. 4 is an isometric view of a prior art standard ATO fuse.

FIG. 5 is an isometric view of a prior art automotive tubular glass fuse.

FIG. 6 is an isometric view of a prior art automotive fuse holder.

FIG. 7 is cross section of the plug in the standard ATO fuse embodiment along lines A-A′.

FIG. 8 is an isometric view of tubular fuse embodiment.

FIG. 9 is a schematic view of the instant invention used with a newly installed fuse box.

### DESCRIPTION OF THE PREFERRED EMBODIMENTS

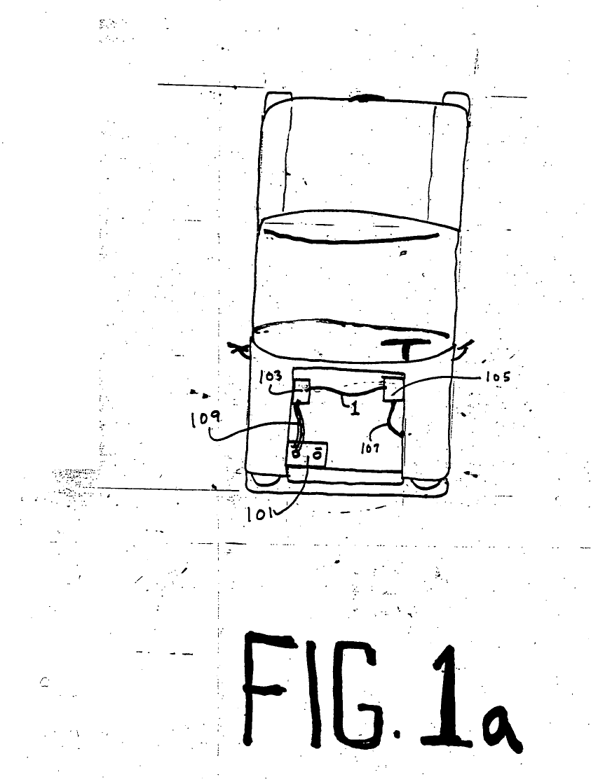

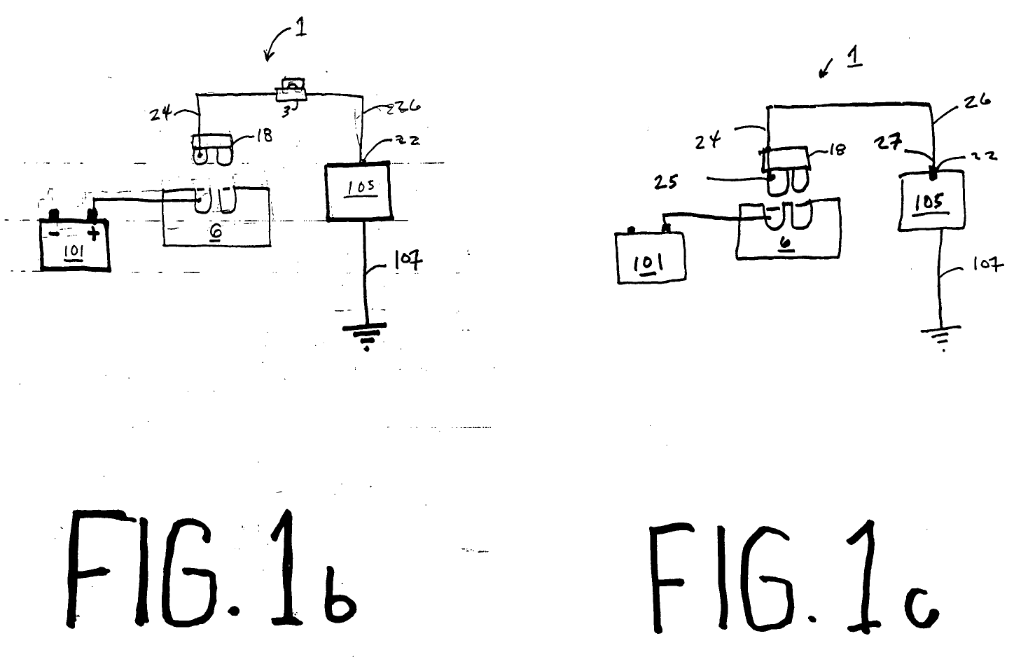

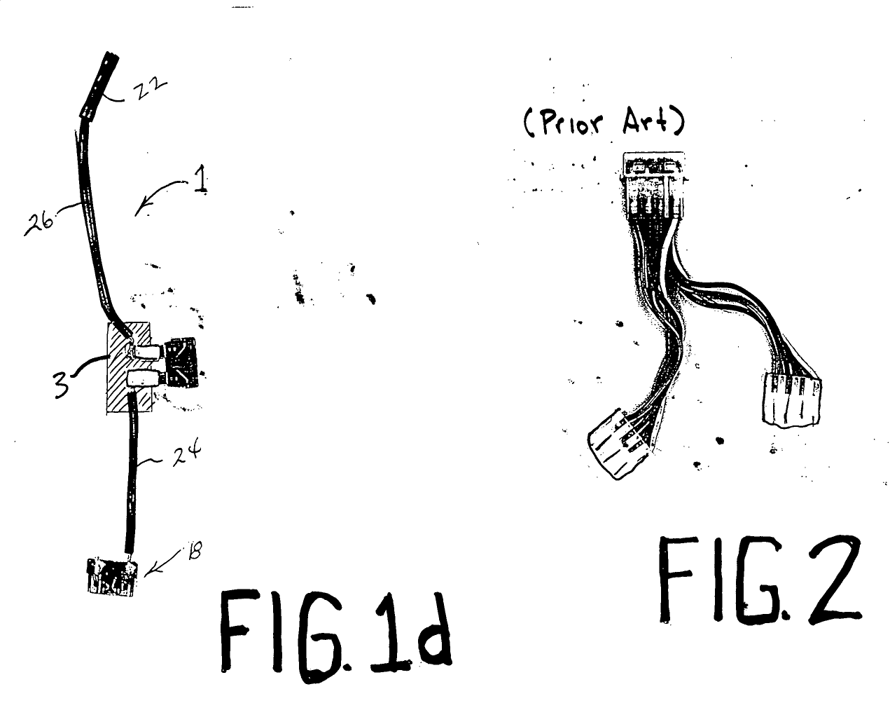

Referring to FIG. 1a the instant invention is an improved accessory fuse harness 1 that allows easy connection of electronic devices to an existing automobile electrical system. The instant invention connects a battery 101 to a fuse box 103 into which the instant invention 1 connects the fuse box to an accessory 105 that is connected to a ground 107 that is connected to the automobile chassis. The battery 101 is connected to the fuse box via a positive wire 109 that provides electrical energy.

Now referring to FIG. 1b the fuse harness 1 can contain a fuse holder 3 that can protect the accessory 105 from electrical surges. The slot end 18 is inserted into the empty slot 16 thereby causes a connection form the battery 101 to the accessory 105. When using a fuse holder 3 it is inserted between the first end 25 and second end 27 of the electrical lead 24,26.

Now referring to FIG. 1c the instant invention is illustrated in its most simple form. A fuse holder 3 is not required. When used without a fuse holder 3, the electrical lead 26 has a first end 25 and a second end 27. The first end 25 is connected to the active prong in the plug end 18, and the second end 27 is connected to the connecting means 22 which is in turn connected to the accessory 105.

Now referring to FIG. 1d the fuse harness has a slot end 18 and lead 24 and fuse holder 3 and lead 26 and a connecting means 22 to the accessory 105. The use of connecting means 22 to make an electrical connection is well know in the art.

Now referring to FIG. 2 the use of electrical harnesses 2 are very well known the art.

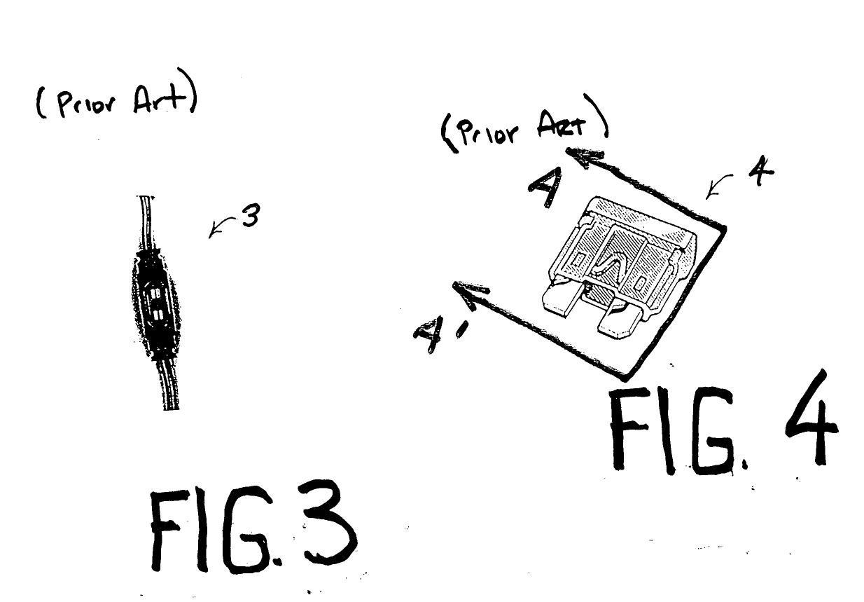

Now referring to FIG. 3 the use of fuses in a new wiring configuration is also known in the art.

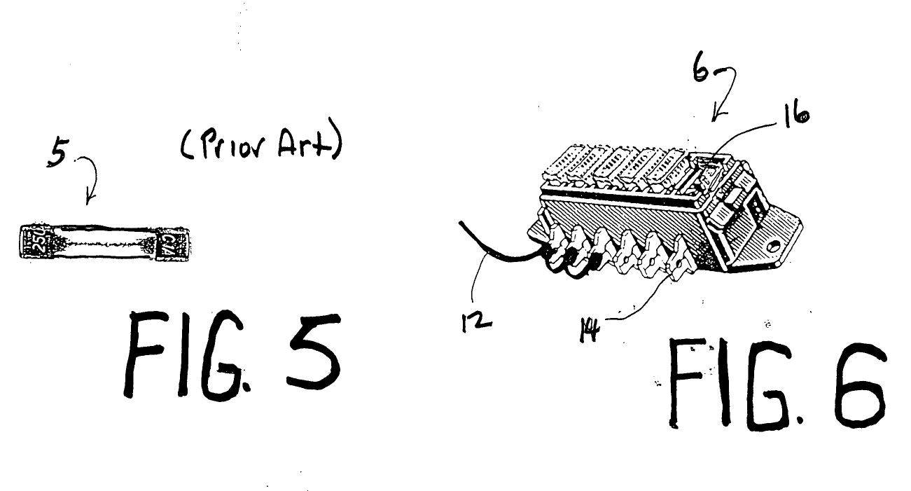

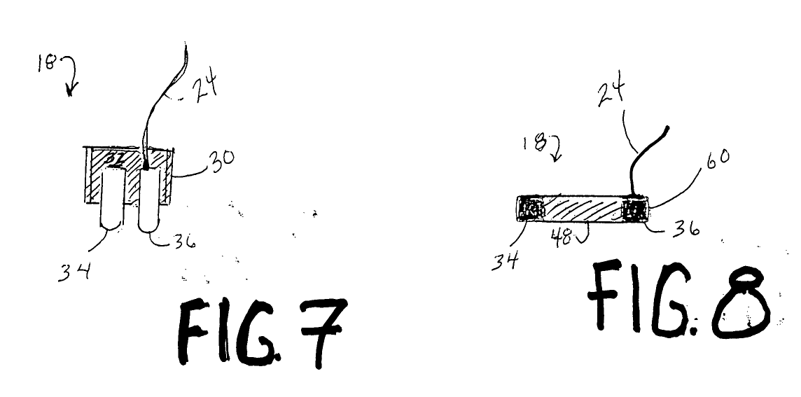

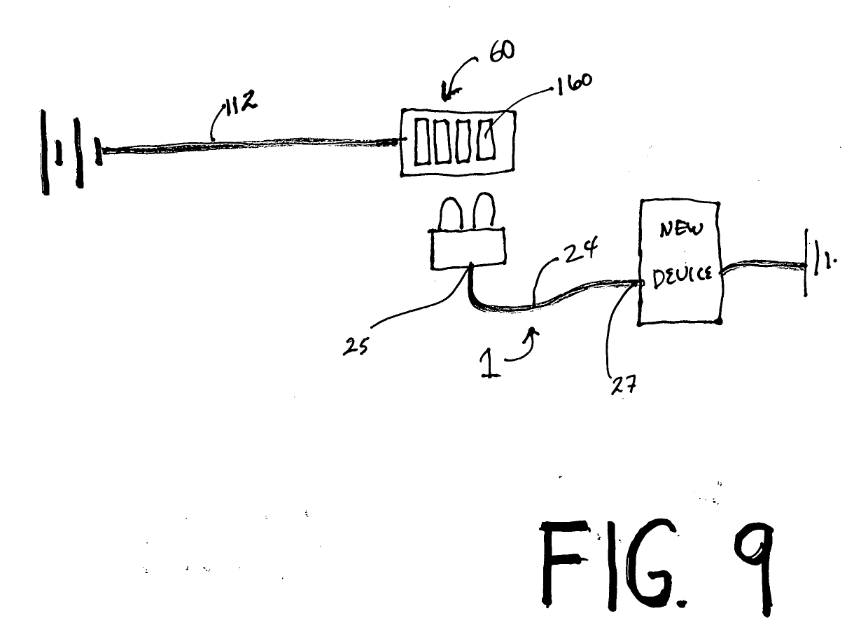

Automobiles use two types of fuses. Now referring to FIG. 4, the most commonly used fuse 4 in a newer automobile is the standard ATO fuse. Now referring to FIG. 5, some older automobiles will use a glass tubular fuse 5.

Now referring to FIG. 6, all automobiles use a fuse box 6 that takes either the standard ATO fuse 4 or the glass-tubular fuse 5 that is used to protect against overload and over current conditions. The instant invention 1 requires either a blank slot 10 in an existing fuse box 6, or the installation of new fuse box 6. For purposes of this application it is not germane if an existing or an added fuse box is used. Each fuse box 6 requires a connection to a power supply via a conductive 12 wire, or the addition of a new connection 14 to a hot lead. An empty slot 16 is be used to receive the plug end of the instant invention.

Referring again to FIG. 1 the instant invention has a slot end 18 connected to an optional fuse receptacle 20 via a conductive wire 24, which is connected to a attaching means 22 also via a conducting wire 26. The attaching means 22 is a convenience to the use and is not required to constitute the instant invention.

Now referring to FIG. 7 the slot end 18 has a plug 30 that is constructed of insulating material 32 that contains a dummy prong 34 and an active prong 36. The active prong is connected to the optional fuse receptacle via a conduction wire 24. The optional fuse receptacle 40 is connected to the accessory via a conductive wire 26. A connective means 22 will made use of the instant invention easier to connect to the accessory to be added

### Glass Fuse Embodiment

Now referring to FIG. 8, a fuse box that uses a tubular-glass fuse will require the an embodiment that will utilize a cylinder 44 that appears similar to a tubular glass fuse in size and shape, but the glass portion will be substituted with a non-conductive material 48. The most efficient method of manufacture of the tubular-glass embodiment is to band the first end 52 of a rod made of non-conductive material 48 with a non-conductive sheath 56 that has the same diameter of the fuse 5 it will replace. The second end of the rod 60 would be sheathed with a conductive material 36 to which is connected a conductive wire 24. The remainder of the embodiment is identical to the standard ATO embodiment.

Wiring Instructions

Now referring to FIG. 9 a vehicle that does not have a blank hot fuse slot an additional fuse holder 60 will need to be installed. The hot lead 112 would be soldered to the input terminal (or terminals) on the additional fuse holder 6 and be electrically connected to the positive terminal. A fuse harness 1 would be inserted into a hot slot 160 as used with other embodiments of the invention.

Other Fuses

Many types of fuses are in use in wide variety of equipment. In each of these instances the fuse to be replaced would have two ends. One end would a dummy end, and the other would be the hot end as in the first two embodiments

### Other Embodiments Possible

While several embodiments of the present invention have been shown and described, it will be apparent to those skilled in the art that many changes and modifications may be made without departing from the invention in its broader aspects.

For example, the types and size of wiring used, the power capability and size of equipment, how to connect the ground wire, and other types of fuses to use.

I claim:

1. An improved accessory fuse harness comprising a plug end having an active plug and a dummy plug, an electrical lead having a first end and a second end,
wherein when the active plug is connected to said first end of the electrical lead, and said end of the electrical lead is connected to a connecting means, and said connecting means is connected to an accessory, said accessory is provided electrical energy when said plug end is inserted into a fuse box.

2. An improved accessory fuse harness comprising a plug end having an active plug and a dummy plug, an electrical lead having a first end, a second end, and a fuse holder containing a fuse,
wherein when the active plug is connected to said first end of the electrical lead, and said end of the electrical lead is connected to a connecting means, and said connecting means is connected to an accessory, said accessory is provided electrical energy when said plug end is inserted into a fuse box.

3. The fuse harness in claim 1 wherein said plug end resembles an ATO fuse.

4. The fuse harness in claim 1 wherein said plug end resembles an glass tube fuse.
